(19) United States
(12) Patent Application Publication
(10) Pub. No.: US 2026/0228662 A1
(43) Pub. Date: Aug. 6, 2026

(54) ARTIFICIAL INTELLIGENCE ASSISTED ESTIMATION FOR ENHANCING AGILE TEAM CERTAINTY

(71) Applicant: FIDELITY INFORMATION SERVICES, LLC, Jacksonville, FL (US)

(72) Inventors: Mohammed Nazaar Mohamed YUSOOF, Bengaluru (IN); Amiya BUDHIA, Bengaluru (IN); Kavitha ANNAMALAI, Hosur (IN)

(73) Assignee: FIDELITY INFORMATION SERVICES, LLC, Jacksonville, FL (US)

(21) Appl. No.: 19/529,409

(22) Filed: Feb. 4, 2026

Related U.S. Application Data
(60) Provisional application No. 63/753,557, filed on Feb. 4, 2025.

(51) Int. Cl. G06Q 10/0631; G06F 8/10; G06N 3/045; G06N 3/08

(52) U.S. Cl. CPC G06Q 10/06313; G06F 8/10; G06N 3/045; G06N 3/08

(57) ABSTRACT

A system is disclosed for automatically estimating the time required to complete software development tasks using project and time data. The system extracts feature details from project management tools and retrieves corresponding time-tracking information. A large language model processes this information to generate machine-learning features, which are used to train a neural network that predicts development effort. The system may further fine-tune the language model using historical feature data and associated work items to improve accuracy. A user interface allows entry of a feature identifier, generation of predicted work items, and display of estimated hours, which may be updated based on team productivity or user input. The system also supports deploying the trained model across distributed computing nodes, integrating multiple estimation APIs, and retraining the model using recent sprint data or updated feature information.

### CROSS-REFERENCE TO RELATED APPLICATIONS

This disclosure claims priority to U.S. Provisional Application No. 63/753,557, filed Feb. 4, 2025, the contents of which are incorporated herein in its entirety for all purposes.

### BACKGROUND

The present disclosure generally relates to systems and methods for implementing an artificial intelligence (AI) assisted estimation tool for enhancing team certainty. The tool may be configured to automatically estimate features when employing the Agile development method.

Many software development companies follow some form of the Agile development method. In the Agile development method, product managers set forth high-level requirements and subsequently work with the enterprise architects, solution architects, and subject matter experts to expand the requirements and provide high-level estimations. Based on the high-level estimations, the product managers can prioritize among the multiple competing features.

In complex software solutions, especially with microservices architecture, there are many independent tasks participating in a coordinated orchestration to achieve several different simultaneous functionalities. These tasks may be owned and/or maintained by different teams in remote locations; these tasks may further span across several different fields of expertise. To provide a high-level estimation in this type of architecture, product managers are challenged with the difficult endeavor of obtaining an accurate overall perspective of the solution, as well as having the knowledge about the various processes and tools used by several different teams working in distinct technical areas. As such, providing high-level estimations can become a complicated task that is prone to error.

To make matters worse, under current operations, most features of development methods are estimated by architects or product managers who do not perform the development work themselves. Moreover, each feature may be split and worked on by several teams simultaneously, further complicating the landscape and preventing these teams from having the overall, big-picture perspective on how each feature fits into the project.

Accurate estimation of features at an early stage is critical for product managers to prioritize based on an effort versus value trade-off. However, estimation of features before performing a full solution and refinement process is challenging and is typically based on crude tools and/or wild guesses. Such estimates (such as blindly assigning a certain number of hours to each type of task) rarely correspond to the ground truth and tend to be vulnerable to bias based on the professional experience and competence of the estimator. As a result, there is the possibility for two different estimators to provide different estimates for the same feature.

Further, features may require modification as additional information becomes available and/or as market demands change, often necessitating a re-estimation of the features. However, there is rarely any feedback provided to the estimators to correct their processes and assumptions on which their estimates are provided. Furthermore, the estimators may fail to consider the productivity improvements gained by the experience of developers or the productivity reductions that may result from attrition. Likewise, the amount of time taken to develop a feature may vary significantly depending on which team is employed to develop it.

In sum, estimates may be provided by those without an overall perspective and/or expertise in the solution; estimates may be biased based on the experience of the estimators; estimates may not be aligned with the ground truth; and there is no feedback mechanism to improve the estimation process based on the ground truth.

### SUMMARY

A solution is disclosed which includes an AI assisted estimation engine, which may provide a tool that can automatically and accurately estimate features based on historical data. Companies who have employed the Agile development method for several years may store past data. For example, past features may be stored in project management tools (e.g., Jira or Rally). In another example, teams may have entered the amount of time consumed for the development of various features in time tracking tools (e.g., Planview or Clarity). Specifically, the availability of past data, particularly past feature and time data, may provide the resources to train a model to automatically and accurately estimate features based on historical data.

Advantages of the disclosed estimation engine include providing accurate estimates that are based on ground truth; providing instantaneous estimates when features are created; providing updated estimates in real-time based on feature and/or market changes; providing increased time and resources to product managers, architects, and subject matter experts to focus on solutions; and providing automatic adjustments of estimates based on the productivity changes of teams.

Disclosed embodiments relate to an AI assisted estimation engine. In some embodiments, the engine comprises, relies upon, utilizes, optionally utilizes, or is an algorithm that is based upon at least one or more of the following: (a) extracting historical data (e.g., epic details) from project management tools; (b) extracting actual time data from time tracking tools; (c) using a Large Language Model (LLM) (e.g., transformer) to engineer machine learning (ML) features; (d) training a neural network model using the engineered ML features; and (e) deploying the neural network model (e.g., for use in a Kubernetes cluster). In some embodiments, the LLM may be fine-tuned to directly predict the number of hours needed for a certain task. In some embodiments, an indirect approach is used for estimating features to make the solution more interpretable.

In some embodiments, the system may include at least one processor and a non-transitory computer-readable medium storing instructions that, when executed by the at least one processor, cause the at least one processor to perform operations including: extracting at least one project management detail associated with a task from a plurality of project management details obtained from at least one project management tool; extracting at least one time detail associated with the task from a plurality of time details; predicting, using a large language model (LLM), at least one machine learning feature based on the extracted project management detail and the extracted time detail; training a neural network model based on the machine learning feature predicted by the LLM; and deploying the trained neural network model to estimate an amount of time required to complete the task.

In some embodiments, the method may include extracting at least one project management detail associated with a task from a plurality of project management details from at least one project management tool; extracting at least one time detail associated with the task from a plurality of time details; predicting, using a large language model (LLM), at least one machine learning feature based on the at least one project management detail and the at least one time detail; training a neural network model based on the at least one machine learning feature predicted by the LLM; and deploying the trained neural network model to estimate an amount of time required to complete the task.

### BRIEF DESCRIPTION OF THE DRAWINGS

FIG. 1 depicts a schematic of an embodiment of the AI assisted method for estimating features including extracting epic details; extracting time actuals, engineering ML features; training neural network; and deploying model, consistent with embodiments of the present disclosure.

FIG. 2 depicts a schematic of an embodiment of the AI assisted method for estimating features, consistent with embodiments of the present disclosure.

FIG. 3 depicts an exemplary UI screen, consistent with embodiments of the present disclosure.

FIG. 4 depicts an exemplary UI screen, consistent with embodiments of the present disclosure.

FIG. 5 depicts an exemplary UI screen, consistent with embodiments of the present disclosure.

FIG. 6 depicts a schematic of a prediction sequence diagram consistent with embodiments of the present disclosure.

### DETAILED DESCRIPTION

In the Agile development method, an epic may include a body of work that may be broken down into specific tasks (i.e., user stories) based on the needs and/or requests of clients and end-users. In some embodiments, an epic may assist in managing tasks.

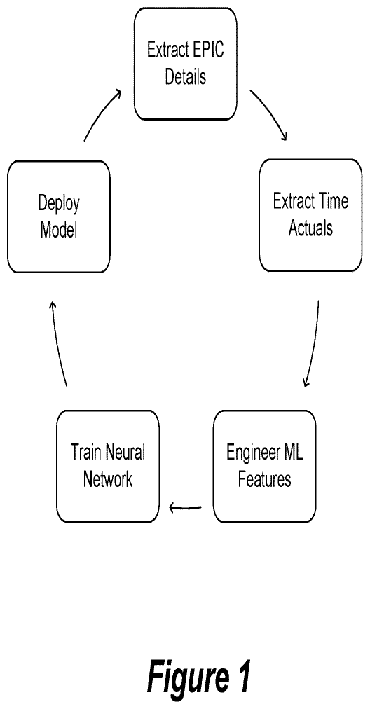

FIG. 1 depicts a schematic of an embodiment of the AI assisted method for estimating features and includes the following steps: extract epic details; extract time actuals, engineer ML features; train neural network; and deploy model.

### Extract Epic Details

Embodiments of the present disclosure may include extracting and storing details by one or more computer systems. In some embodiments, the one or more computer systems may use the extracted details to train models. Project management tools (such as Jira and Rally) may provide a Representational State Transfer (REST)/Hypertext Transfer Protocol (HTTP) based application programming interface (API) to retrieve details of the epic. In some embodiments, the one or more computer systems may extract and/or store several details for training the model.

In some embodiments, extracting project management details may include retrieving, via a REST or HTTP API of the project management tool, one or more parameters associated with the project management detail. In some embodiments, the parameters may include one or more of epic names, benefit statements, feature descriptions, acceptance criteria, comments, discussions, team details, functional and technical area identifiers, and user story details. In some embodiments, the system may aggregate the retrieved parameters to generate a comprehensive input for processing by the LLM.

In some embodiments, the one or more computer systems may extract and/or store an epic name. An epic name may include a few words that succinctly describe the functionality.

In some embodiments, the one or more computer systems may extract and/or store a benefit statement. A benefit statement may include a description of the customer benefit achieved.

In some embodiments, the one or more computer systems may extract and/or store a feature description. A feature description may include the changes needed in the system to achieve proper functionality, changes needed in integration systems, and the like.

In some embodiments, the one or more computer systems may extract and/or store acceptance criteria of the feature. Acceptance criteria of the feature may include lists of acceptance criteria, such as behavior from individual services, message events, and the like.

In some embodiments, the one or more computer systems may extract and/or store comments, discussions, and/or notes. Comments, discussions, and/or notes may include interactions between stakeholders regarding potential impact, solution approaches, and the like.

In some embodiments, the one or more computer systems may extract and/or store team details. Team details may include details about a team that is planned to develop a feature. For example, each team may have various levels of productivity and skill set, resulting in discrepancies in the time and effort needed to develop a certain feature. In some embodiments, the one or more computer systems may may account for team details as a factor in estimating features.

In some embodiments, the one or more computer systems may extract and/or store functional and/or technical areas. Different functional areas may have varying integration requirements, resulting in added complexity. For example, a code change in a certain functional area may necessitate integration changes in several subsystems. Conversely, in other examples, a code change in other functional areas may have no impact on other subsystems, even when the code change is significant (e.g., overdraft or general ledger in a banking system; medical image reading or physician recommendation systems in medical software; and the like).

Different technical areas may produce varying challenges. For example, different technical areas may result in varying logging and traceability requirements; event-based framework enhancements; and the like.

In some embodiments, the one or more computer systems may extract and/or store user stories. User stories may include descriptions of the story; acceptance criteria of the story; comments, discussions, and/or notes; and the like.

The extracted details described above include information about the enhancement and/or functionality of the system, which may be used by manual estimation techniques as a baseline. In some embodiments, one or more computer systems may combine the information to generate a comprehensive reference that may serve as an input for the transformer to engineer further ML features.

### Extract Time Details

Embodiments of the present disclosure may include extracting and storing time details by one or more computer systems. In some embodiments, the one or more computer systems may use the extracted time details to train models. Time tracking tools (such as Planview or Clarity) may provide HTTP based API to retrieve the amount of time logged by developers to develop a project. When employing Agile development methods, teams may create tasks using the same reference identifier (e.g., Feature ID or Epic ID) that was used in the project management tool (e.g., Jira or Rally). In some embodiments, the one or more computer systems may train the model based on the amount of time logged by team members in relation to historical features and historical time details.

In some embodiments, the project management tool itself may track time details, rather than a time tracking tool. Embodiments of the present disclosure may include receiving, extracting, and/or storing time details from any source. Regardless of the source, accurate time details may assist in providing robust estimates.

In some embodiments, extracting time details may include retrieving an amount of time logged on the at least one time tracking tool. In some embodiments, extracting time details may include retrieving an amount of time logged on the at least one project management tool.

### Engineer ML Features

Embodiments of the present disclosure may include engineering ML features by one or more computer systems. In some embodiments, one or more computer systems may employ a one-step approach. In a one-step approach, one or more computer systems may directly fine-tune a Bidirectional Encoder Representations from Transformers (BERT) model to make predictions. In some embodiments, one or more computer systems may employ a two-step approach. In a two-step approach, one or more computer systems may first fine-tune a BERT model to predict certain ML features, and in turn use the predicted ML features as input to a neural network model to predict the hours required for development. In some embodiments, a first step of a two-step approach may include fine-tuning a BERT model to predict certain ML features. In some embodiments, a second step of a two-step approach may include using the predicted ML features as an input to a neural network model to predict the hours required for development. In some embodiments, the two-step approach may help to enhance the explainability of the system.

In some embodiments, a BERT model may engineer ML features based on the details of the product management tool, time tracking tool, and/or epic/feature/story details. In some embodiments, engineered ML features may include: a number of components (subsystems) impacted; a number of stories needed to finish the enhancement; a number of acceptance criteria listed in the product feature; a number of REST APIs that are required to be modified; a number of new REST APIs required to be developed; a number of events required to be modified; a number of new events required to be developed; a number of batch processes that are impacted; a number of new batch processes that are required; a number of database tables modified; a number of new database tables to be created; a number of user interface (UI) Screens required to be modified; a number of new UI screens to be developed; and/or a Perceived Complexity of the feature (which may be based on a functional/technical area). In some embodiments, the LLM may include a BERT model.

In some embodiments, predicting the machine learning features using the LLM may include engineering one or more feature metrics, including an amount of components or subsystems impacted, an amount of user stories required, an amount of acceptance criteria documented, an amount of APIs impacted or required, an amount of events impacted or required, an amount of batch processes impacted or required, an amount of database tables impacted or required, an amount of user interface screens impacted or required, or a complexity metric associated with the feature.

In some embodiments, predicting the at least one machine learning feature may further include predicting the at least one machine learning feature based on a productivity level associated with a designated team. In some embodiments, predicting the at least one machine learning feature may further include updating the estimated amount of time required to complete the task based on the team's productivity level.

The above list of ML features is not exhaustive and is used for representative purposes. In some embodiments, each project may have a different architecture, which may require different ML features to be engineered from the data. In some embodiments, a determination of how each of the candidate ML features impacts the time needed to develop and deliver a feature may be included in the prediction process.

A representative record of ML features is provided in Table 1.

TABLE 1

| ML Features | For Training | For Prediction |
|---|---|---|
| EPIC NAME | Extracted from PM tools to | Not included in total hours |
| | fine tune BERT | estimation |
| Benefit Statement | Extracted from PM tools to | Not included in total hours |
| | fine tune BERT | estimation |
| Description of the EPIC | Extracted from PM tools to | Not included in total hours |
| | fine tune BERT | estimation |
| Acceptance Criteria | Extracted from PM tools to | Not included in total hours |
| | fine tune BERT | estimation |
| Comments | Extracted from PM tools to | Not included in total hours |
| | fine tune BERT | estimation |
| User story Details | Extracted from PM tools to | Not included in total hours |
| | fine tune BERT | estimation |
| Functional/Technical | Extracted from PM tools to | Engineered using fine- |
| Area | fine tune BERT | tuned BERT Model |
| Team | Extracted from PM tools to | Engineered using fine- |
| | fine tune BERT | tuned BERT Model |
| # of components | Populated from the solution | Engineered using fine- |
| impacted | document | tuned BERT Model |
| # of stories required | Populated from the solution | Engineered using fine- |
| | document | tuned BERT Model |
| # of acceptance criteria | Populated from the solution | Engineered using fine- |
| documented | document | tuned BERT Model |
| # of webservices | Populated from the solution | Engineered using fine- |
| impacted | document | tuned BERT Model |
| # of new webservices | Populated from the solution | Engineered using fine- |
| needed | document | tuned BERT Model |
| # of events impacted | Populated from the solution | Engineered using fine- |
| | document | tuned BERT Model |
| # of new events needed | Populated from the solution | Engineered using fine- |
| | document | tuned BERT Model |
| # of batch processes | Populated from the solution | Engineered using fine- |
| impacted | document | tuned BERT Model |
| # of new batch | Populated from the solution | Engineered using fine- |
| processes needed | document | tuned BERT Model |
| # of DB tables impacted | Populated from the solution | Engineered using fine- |
| | document | tuned BERT Model |
| # of new DB Tables | Populated from the solution | Engineered using fine- |
| needed | document | tuned BERT Model |
| # of UI Screens | Populated from the solution | Engineered using fine- |
| impacted | document | tuned BERT Model |
| # of new UI Screens | Populated from the solution | Engineered using fine- |
| needed | document | tuned BERT Model |
| Complexity of the EPIC | Populated from the solution | Engineered using fine- |
| | document | tuned BERT Model |
| Estimated Hours | Actual hours from time | Predicted using a Neural |
| | tracking tools | Network |

### Train Neural Network

Embodiments of the present disclosure may include training a neural network by one or more computer systems. In some embodiments, the one or more computer systems may use the engineered ML features as input (along with additional existing data) to train a supervised model. In some embodiments, the one or more computer systems may use an estimated hours attribute as a label for supervision. In some embodiments, the one or more computer systems may train a supervised model using at least one ML library (such as PyTorch or TensorFlow).

### Deploy Model

Embodiments of the present disclosure may include deploying the trained neural network model. In some embodiments, the neural network model is packaged inside a web application and deployed in a Kubernetes Cluster. A web application may include a program that runs in a web browser and is accessed over the internet. A Kubernetes cluster may include a group of computing nodes that run containerized applications. In some embodiments, deploying a neural network model may include deploying in a cloud agnostic fashion. In some embodiments, deploying a neural network may include other methods of deployment.

In some embodiments, deploying the model may include an API supported web application. In some embodiments, an API supported web application may include exposing three APIs. In some embodiments, a first API may include a Work Items extraction (or retrieval) API. In some embodiments, a Work Items extraction API may receive a reference identifier, such as a Feature ID, as input and in turn output the expected work items listed in the table. In some embodiments, a Feature ID may refer to a unique identifier assigned by a project management tool to a feature, used to retrieve, correlate, and process all associated feature details, work items, and time data across the system. In some embodiments, a second API (such as an Estimate extraction API) may use these values for estimating hours. In some embodiments, a second API may include an Estimate extraction API. In some embodiments, an Estimate extraction API may receive the work items as input and in turn output the number of hours required to develop. In some embodiments, a third API may include an Estimate update API. In some embodiments, an Estimate update API may include updating the project management tools (e.g., Jira or Rally) with the estimated hours.

In some embodiments, deploying the model may include packaging the trained neural network model within a web application and deploying the trained neural network model in a plurality of computing nodes, such as a Kubernetes Cluster.

In some embodiments, the system may integrate a work items extraction API, an estimate extraction API, and an estimate update API with the at least one project management tool.

In some embodiments, deploying the model may include a UI screen.

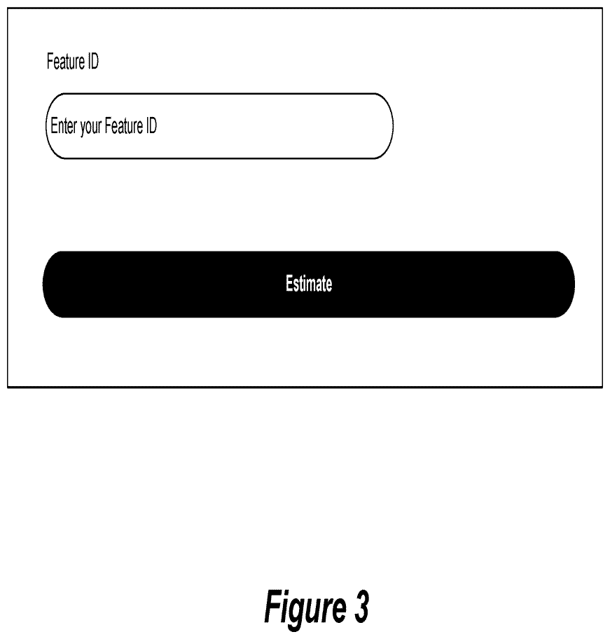

FIG. 3 depicts an exemplary UI screen consistent with embodiments of the present disclosure.

In some embodiments, a UI screen may include a landing screen. In some embodiments, a landing screen may provide a field for a user to enter and submit a Feature ID.

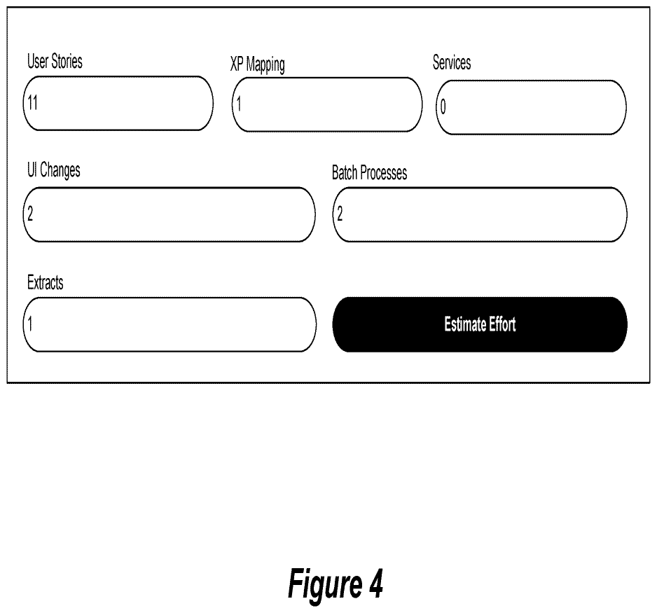

FIG. 4 depicts an exemplary UI screen consistent with embodiments of the present disclosure.

In some embodiments, a UI screen may include a predicted work items screen. In some embodiments, a predicted work items screen may populate based on an entered Feature ID. In some embodiments, a predicted work items screen may include at least one of user stories, XP mapping, services, UI changes, batch process, and extracts quantity. In some embodiments, a predicted work items screen may provide an opportunity to update the predicted counts of work items before estimating. In some embodiments, a predicted work items screen may help to explain the overall process to the user, rather than an arbitrary number without context or interpretation.

In some embodiments, deploying the trained neural network model may include entering or receiving a reference identifier, such as a Feature ID, into a landing screen of a user interface. In some embodiments, deploying the trained neural network model may include generating a work items prediction based on the entered or received reference identifier. In some embodiments, deploying the trained neural network model may include displaying the estimated amount of time required to complete the task based on the generated work items prediction.

In some embodiments, the system may display one or more machine learning features on a user interface and update the estimated amount of time required to complete the task based on at least one user input, such as a user-provided modification.

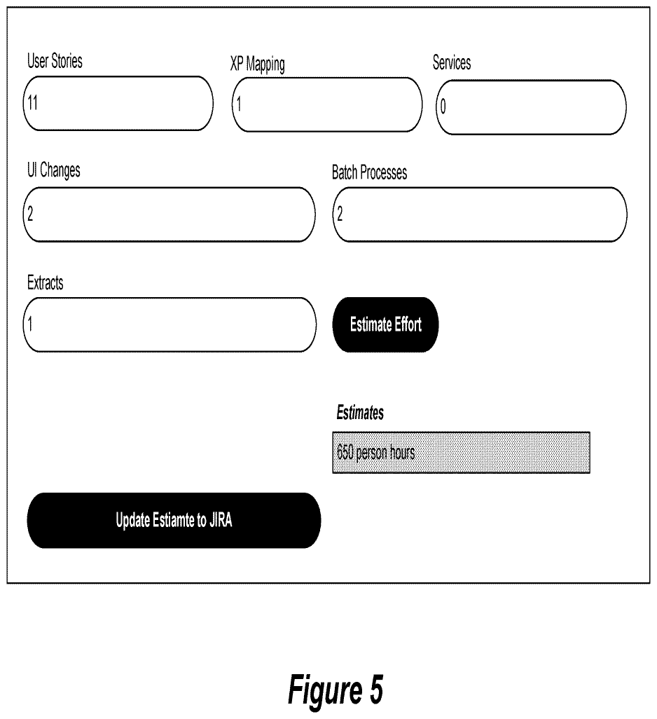

FIG. 5 depicts an exemplary UI screen consistent with embodiments of the present disclosure.

In some embodiments, a UI screen may include an estimate screen. In some embodiments, an estimate screen may populate a number of person-hours required to complete a task. In some embodiments, a user may have an opportunity to edit the different fields. In some embodiments, updates or edits may be left to the discretion of the user. In some embodiments, an estimate screen may include at least one of user stories, XP mapping, services, UI changes, batch process, and extracts quantity. In some embodiments, an estimate may be updated based on updates to the different fields.

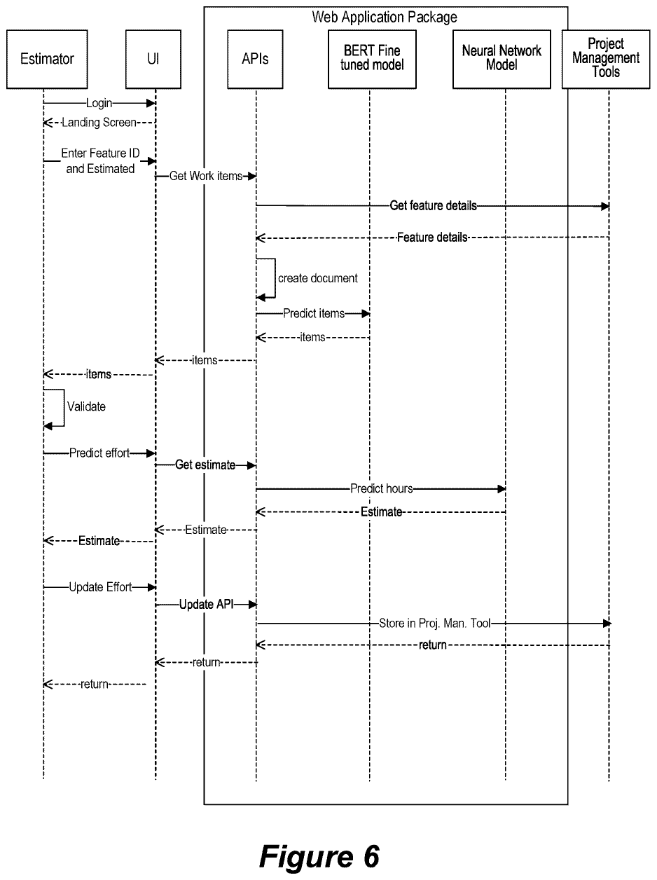

FIG. 6 depicts a schematic of a prediction sequence diagram consistent with embodiments of the present disclosure. In some embodiments, one or more computer systems may perform a prediction sequence. In some embodiments, a prediction sequence may include an estimator, a UI, APIs, a fine-tuned BERT model, a neural network model, and at least one project management tool. In some embodiments, a prediction sequence may include a web application package. In some embodiments, a web application package may include APIs, a fine-tuned BERT model, and a neural network model.

In some embodiments, one or more computer systems may include at least one of a UI, one or more APIs, at least one fine-tuned BERT model, at least one neural network model, and at least one project management tool. In some embodiments, a prediction sequence may include an estimator using one or more computer systems to login to a system. In some embodiments, an estimator may login to a system using a UI. In some embodiments, a UI may direct an estimator to a landing screen. In some embodiments, an estimator may enter a Feature ID. In some embodiments, an estimator may enter a Feature ID using a UI. In some embodiments, entering a Feature ID may retrieve and/or populate work items. In some embodiments, entering a Feature ID may retrieve and/or populate work items from at least one API. In some embodiments, at least one project management tool (such as Jira or Rally) may provide feature details. In some embodiments, at least one API may generate a document containing feature details. In some embodiments, items may be predicted based on the feature details. In some embodiments, items may be predicted and/or communicated using at least one of a fine-tuned BERT model, APIs, a UI, and an estimator.

In some embodiments, an estimator may validate items. In some embodiments, an estimator may predict an amount of effort required and retrieve an estimate. In some embodiments, an estimator may predict an amount of effort required using a UI and may retrieve an estimate from APIs. In some embodiments, a number of hours is predicted based on a predicted effort and an estimate. In some embodiments, an estimate is provided to an estimator. In some embodiments, an estimate is provided to an estimator based on an estimate generated by a neural network model. In some embodiments, an amount of effort is updated. In some embodiments, an estimator updates an amount of effort using a UI. In some embodiments, an API is updated based on the updated effort. In some embodiments, a project management tool may store an update.

In some embodiments, a prediction sequence may include a web application package. In some embodiments, a web application package may include APIs, a fine-tuned BERT model, and a neural network model.

In some embodiments, the system may calculate a differential between the estimated amount of time required to complete the task and an actual amount of time required to complete the task. In some embodiments, the system may store the estimated amount of time required to complete the task for use in retraining the neural network model.

Embodiments of the present disclosure may include retraining the model. In some embodiments, retraining the model may provide the benefit of avoiding drift. In some embodiments, retraining the model should include using the features that were completed in the recently completed sprint. In some embodiments, the model may be updated or retrained with additional data upon completion of each sprint. In some embodiments, retraining the model may enable the model to be updated based on the productivity improvements of a team or other architectural changes. In some embodiments, retraining the model may provide the benefit of maintaining recent and accurate estimates and avoiding model drift. In some embodiments, a project team may elect to train the system based on only the most recent features to avoid including older, outdated features that may not reflect current estimates.

Embodiments of the present disclosure may include providing explainable AI. In some embodiments, a two-step approach is provided. In some embodiments, a two-step approach may provide increased explainability to relevant teams regarding how the features are populated with individual work items and how estimates are generated based on the work items. In some embodiments, a two-step approach may provide an opportunity for experienced estimators to update the populated values before estimating. In some embodiments, a two-step approach may assist with retraining and updating the model to provide improved estimates.

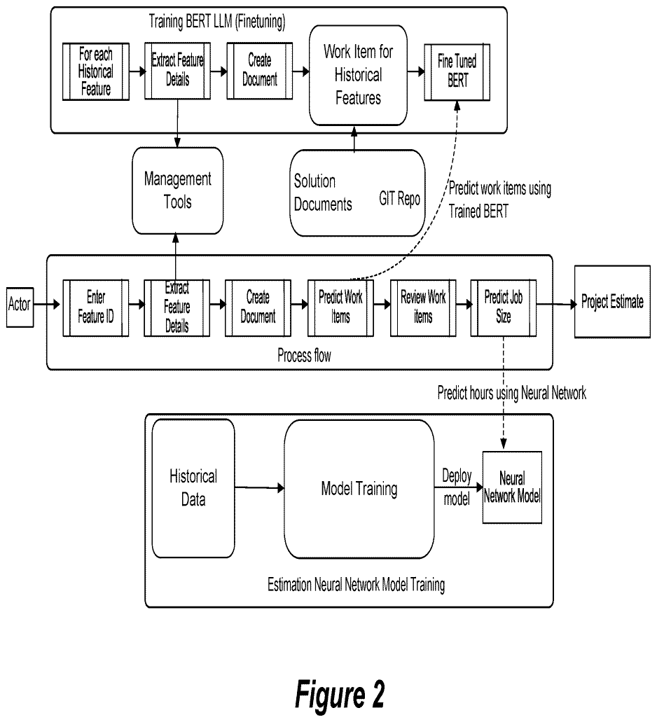

FIG. 2 depicts a schematic of an embodiment of the AI assisted method for estimating features.

Embodiments of the present disclosure may include a BERT LLM training/finetuning process. In some embodiments, a BERT LLM training/finetuning process may include extracting feature details based on one or more historical features. In some embodiments, a BERT LLM training/finetuning process may include creating a document based on the extracted feature details. In some embodiments, a BERT LLM training/finetuning process may include determining work items for historical features based on the created document. In some embodiments, a BERT LLM training/finetuning process may include determining work items for historical features based on solution documents and/or data repositories. In some embodiments, a BERT LLM training/finetuning process may include generating the finetuned BERT model based on the work items for historical features. In some embodiments, a fine-tuned BERT model may be used to predict work items in a process flow.

In some embodiments, the system may fine-tune the LLM. In some embodiments, fine-tuning the LLM may include creating a document based on one or more feature details extracted from a plurality of historical features associated with one or more prior tasks. In some embodiments, fine-tuning the LLM may include determining work items associated with the prior tasks based on the created document. In some embodiments, fine-tuning the LLM may include generating a fine-tuned LLM model using the determined work items.

In some embodiments, the system may update the machine learning features and retrain the neural network model. In some embodiments, the system may update, using the fine-tuned LLM, the at least one machine learning feature predicted by the LLM. In some embodiments, the system may retrain the neural network model based on the at least one updated machine learning feature predicted by the fine-tuned LLM. In some embodiments, the system may deploy the retrained neural network model to re-estimate the amount of time required to complete the task.

In some embodiments, the system may retrain the neural network model based on updated project management details or updated time details to maintain the accuracy of time estimation outputs.

In some embodiments, the system may retrain the neural network model using one or more features completed in a most recently completed sprint to update the model and reduce estimation drift.

Embodiments of the present disclosure may include a neural network model training process. In some embodiments, a neural network model training process may include using historical data to train a neural network model. In some embodiments, a neural network model training process may include deploying a trained neural network model to predict hours for a particular task or job.

Embodiments of the present disclosure may include a process flow. In some embodiments, a process flow may include an actor (such as an estimator) entering a Feature ID. In some embodiments, a process flow may include extracting feature details based on an entered Feature ID. In some embodiments, a process flow may include creating a document based on the extracted feature details. In some embodiments, a process flow may include predicting work items based on the created document. In some embodiments, a process flow may include predicting work items based on a trained BERT model. In some embodiments, a process flow may include reviewing the predicted work items. In some embodiments, a process flow may include predicting a job or task size based on the reviewed work items. In some embodiments, a process flow may include predicting a job or task size based on the hours predicted by the trained neural network model.

The advantages of this system include providing accurate estimates that are based on ground truth; providing instantaneous estimates when features are created; providing updated estimates in real-time based on feature and/or market changes; providing increased time and resources to product managers, architects, and subject matter experts to focus on solutions; and providing automatic adjustments of estimates based on the productivity changes of teams.

A non-transitory computer-readable medium may be provided that stores instructions for a processor for implementing a contextual engagement decision engine, consistent with embodiments in the present disclosure. For example, the instructions stored in the non-transitory computer-readable medium may be executed by a processor in part or in entirety. Common forms of non-transitory media include, for example, a floppy disk, a flexible disk, a hard disk, a solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), an Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, Hypertext Markup Language (HTML), HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the sample claim below are to be interpreted broadly based on the language employed in the claims and not limited to examples described in the present specification or during the prosecution of the application. The examples are to be construed as non-exclusive. Furthermore, the steps of the disclosed methods, or portions of the steps of the disclosed methods, may be modified in any manner, including by reordering steps, inserting steps, repeating steps, and/or deleting steps (including between steps of different exemplary methods). It is intended, therefore, that the specification and examples be considered as illustrative only, with a true scope being indicated by the following claims and their full scope of equivalents.

What is claimed is:

1. A system for estimating project management tasks, the system comprising:
at least one processor; and
a non-transitory computer-readable medium containing instructions that, when executed by the at least one processor, cause the at least one processor to perform operations comprising:
extracting at least one project management detail associated with a task from a plurality of project management details from at least one project management tool;
extracting at least one time detail associated with the task from a plurality of time details;
predicting, using a large language model (LLM), at least one machine learning feature based on the at least one project management detail and the at least one time detail;
training a neural network model based on the at least one machine learning feature predicted by the LLM; and
deploying the trained neural network model to estimate an amount of time required to complete the task.

2. The system of claim 1, wherein the extracting the at least one project management detail comprises:
retrieving, via a Representational State Transfer (REST)/Hypertext Transfer Protocol (HTTP) application programming interface (API) of the at least one project management tool, at least one parameter associated with the at least one project management detail, wherein the at least one parameter includes one or more of: an epic name, benefit statement, feature description, acceptance criteria, comments, discussions, team details, functional and technical area identifiers, or user story details; and
aggregating the at least one parameter to generate a comprehensive input for processing by the LLM.

3. The system of claim 1, wherein predicting the at least one machine learning feature comprises engineering one or more of an amount of components or subsystems impacted, an amount of user stories required, an amount of acceptance criteria documented, an amount of application programming interfaces (APIs) impacted, an amount of APIs required, an amount of events impacted, an amount of events required, an amount of batch processes impacted, an amount of batch processes required, an amount of database tables impacted, an amount of database tables required, an amount of user interface screens impacted, an amount of user interface screens required, or a complexity metric.

4. The system of claim 1, wherein the operations further comprise fine-tuning the LLM by:
creating a document based on one or more feature details extracted from a plurality of historical features associated with one or more prior tasks;
determining work items for the one or more prior tasks based on the created document; and
generating a fine-tuned LLM model based on the work items.

5. The system of claim 4, wherein the operations further comprise:
updating, using the fine-tuned LLM, the at least one machine learning feature predicted by the LLM;
retraining the neural network model based on the at least one updated machine learning feature predicted by the fine-tuned LLM; and
deploying the retrained neural network model to re-estimate the amount of time required to complete the task.

6. The system of claim 1, wherein the LLM includes a Bidirectional Encoder Representations from Transformers (BERT) model.

7. The system of claim 1, wherein deploying the trained neural network model comprises:
entering a reference identifier using a landing screen of a user interface;
generating a work items prediction based on the entered reference identifier; and
displaying the estimated amount of time required to complete the task based on the generated work items prediction.

8. The system of claim 1, wherein predicting further comprises predicting the at least one machine learning feature based on a productivity level of a designated team.

9. The system of claim 8, wherein the operations further comprise updating the estimated amount of time required to complete the task based on the productivity level.

10. The system of claim 1, wherein the operations further comprise retraining the neural network model based on at least one of an updated project management detail or an updated time detail.

11. The system of claim 1, wherein extracting the at least one time detail comprises retrieving an amount of time logged on the at least one time tracking tool.

12. The system of claim 1, wherein extracting the at least one time detail comprises retrieving an amount of time logged on the at least one project management tool.

13. The system of claim 1, wherein the operations further comprise retraining the neural network model using one or more features completed in a most recently completed sprint.

14. The system of claim 1, wherein deploying the trained neural network model comprises packaging the trained neural network model within a web application and deploying the trained neural network model in a plurality of computing nodes.

15. The system of claim 1, wherein the operations further comprise integrating a work items extraction application programming interface (API), an estimate extraction API, and an estimate update API with the at least one project management tool.

16. The system of claim 1, wherein the operations further comprise displaying the at least one machine learning feature on a user interface and updating the estimated amount of time required to complete the task based on at least one user input.

17. The system of claim 1, wherein the operations further comprise calculating a differential between the estimated amount of time required to complete the task and an actual amount of time required to complete the task.

18. The system of claim 1, wherein the operations further comprise storing the estimated amount of time required to complete the task for use in retraining the neural network model.

19. A method for estimating project management tasks implemented on at least one processor, the method comprising:
extracting at least one project management detail associated with a task from a plurality of project management details from at least one project management tool;
extracting at least one time detail associated with the task from a plurality of time details;
predicting, using a large language model (LLM), at least one machine learning feature based on the at least one project management detail and the at least one time detail;
training a neural network model based on the at least one machine learning feature predicted by the LLM; and
deploying the trained neural network model to estimate an amount of time required to complete the task.
